(19) United States
(12) Patent Application Publication
(10) Pub. No.: US 2018/0227220 A1
(43) Pub. Date: Aug. 9, 2018

(54) Router Cooperation

(71) Applicant: Microsoft Technology Licensing, LLC, Redmond, WA (US)

(72) Inventor: Suvarna Raju MADHEY, Hyderabad (IN)

(73) Assignee: Microsoft Technology Licensing, LLC, Redmond, WA (US)

(21) Appl. No.: 15/598,028

(22) Filed: May 17, 2017

(30) Foreign Application Priority Data
Feb. 7, 2017 (IN) 201741004376

(51) Int. Cl. H04L 12/725; H04L 29/08; H04L 12/931; H04W 40/20; H04W 72/06; H04W 40/04

(52) U.S. Cl. CPC H04L 45/306; H04L 67/02; H04L 49/201; H04W 84/12; H04W 72/06; H04L 67/1097; H04W 40/04; H04W 40/20

(57) ABSTRACT

A router configured to cooperate with other routers to provide Internet content to users, comprising: a memory for storing data items; a first interface for connecting to the public Internet; a second interface having a local wireless communication range; and a processor configured to: receive a request for a data item comprising Internet content; determine whether the requested data item is stored in the memory; and if so, provide the data item to the user device via the second interface; and if not so, broadcast a message requesting the data item from any other routers in the local wireless communication range, thereby causing that other router to return the data item if that router has the data item available; wherein the router only downloads the Internet content of the data item from the public Internet if it is not returned by one of the other routers.

### RELATED APPLICATION

This application claims priority under 35 U.S.C. 119 or 365 to India Patent Application Serial No. 201741004376 filed Feb. 7, 2017, the disclosure of which is hereby incorporate by reference in its entirety.

### TECHNICAL FIELD

The present invention relates to a system for data sharing between routers to provide Internet content to users.

### BACKGROUND

Local wireless communication networks, such as deployed in public areas (e.g. libraries) and private areas (e.g. workplaces) allow users to connect to the local network in order to access content from a public network such as the public Internet.

Such networks comprise a plurality of routers (also called dataspots or hotspots) which connect to the Internet via an Internet Service Provider (ISP), e.g. using a wired network connection. The routers each output a wireless signal such as a Wi-Fi signal which can be received by devices within range. Hence, devices within range of one (or more) routers are able to connect to the router using its wireless connection and thereby access Internet content. Such local networks are commonplace.

In order to download content from the Internet, a user connects to a router using a user device (e.g. a smartphone, laptop etc.) enabled with an appropriate wireless technology (e.g. Wi-Fi). The user device is then able to send requests for data at a remote server accessible over the Internet by transmitting this request to the router which forwards (or “routes”) it over the Internet, via the ISP, to the remove server which can then return the requested content to the user device for playback to the user (e.g. display a video, play back an audio file etc.).

### SUMMARY

Data usage in these networks is growing drastically. For example:
1. A file may be downloaded by multiple users (e.g. multiple users who are part of the same group messaging app may download the same video)
2. A file may be uploaded by multiple users (e.g. multiple users who are part of the same group messaging app may upload the same video)
3. A file may be downloaded in multiple groups (e.g. by members of different groups of a messaging app)

Today, many people and companies are concerned with “Going Green”, reducing waste, in many areas. The present disclosure envisages that a point may come where this mentality will extend to reducing “waste” in data usage on the Internet and networks in general, where it is generally desired to save bandwidth, i.e. reducing data usage.

The present invention relates to systems, devices and methods to reduce data usage in the public internet network. To do so, “data hotspots” are provided which primarily download data from internet and then share/distribute data to all the registered users which are within range (cf. routers known in the art) and are provided with additional functionality which allows them to sync data with one another to reduce net data usage in the network. For example, sharing a file (such as a video or Powerpoint) between routers, rather than each router performing its own independent download of the file helps to reduce internet usage drastically (and hence also reduce costs for the subscriber to the ISP service as less data are being downloaded overall).

Hence, according to a first aspect of the present invention, there is provided a router configured to cooperate with one or more other such routers to provide Internet content to users, the router comprising: a memory for storing data items available to the router; a first interface for connecting to the public Internet; a second interface being a wireless interface having a local wireless communication range; and a processor configured to: receive a request for a data item comprising Internet content from a user device within the local wireless communication range via the second interface; determine whether the requested data item is stored in the memory; and if the data item is stored in the memory, provide the data item to the user device via the second interface; and if the data item is not stored in the memory, broadcast a message requesting the data item from any one or more other routers in the local wireless communication range, thereby causing that other router to return the data item if that router has the data item available to it; wherein the router only downloads the Internet content of the data item from the public Internet via the first interface for providing to the user device if it is not returned by one of the other routers.

In embodiments, the processor is further arranged to retain the downloaded Internet content in the memory thereby rendering the data item accessible from the memory for providing in response to a later request.

In embodiments, the processor is further arranged to: determine a popularity indicator for the data item; and to use the popularity indicator to determine whether to perform said retaining the downloaded Internet content.

In embodiments, the processor is configured to determine, as the popularity indicator, a number of users associated with the data item, and wherein said retaining of the Internet content is performed in response to the processor determining that the determined number of users exceeds a threshold value.

In embodiments, the threshold value is one. The threshold value may be two, three, etc. (i.e. any integer number, such as 10, 100, 1000 etc.).

In embodiments, the number of users associated with the data item is determined based on metadata of the data item.

In embodiments, the processor is configured to determine the popularity indicator as a type of source from which the request for the data item was received.

In embodiments, the downloaded Internet content is retaining if the type of source is identified as a social media system.

In embodiments, the processor is configured to retain all Internet content it downloads, the stored content being retained at the router for a limited time interval.

In embodiments, the second interface is a Bluetooth interface having a local Bluetooth communication range.

In embodiments, the second interface is a Wi-Fi interface having a local Wi-Fi communication range.

In embodiments, the processor is configured to retain the data item only if a file size of the data item exceeds a threshold file size.

In embodiments, the data item is a video file. The data item may also be an image file, text file, webpage (e.g. Hypertext Markup Language (HTML) file) or any other type of file accessible over the Internet.

According to a second aspect disclosed herein, there is provided a method, performed at a router, of cooperating with one or more other such routers to provide Internet content to users, the router comprising a memory for storing data items available to the router, a first interface for connecting to the public Internet, and a second interface being a wireless interface having a local wireless communication range, the method comprising steps of: receiving a request for a data item comprising Internet content from a user device within the local wireless communication range via the second interface; determining whether the requested data item is stored in the memory; and if the data item is stored in the memory, providing the data item to the user device via the second interface; and if the data item is not stored in the memory, broadcasting a message requesting the data item from any one or more other routers in the local wireless communication range, thereby causing that other router to return the data item if that router has the data item available to it; wherein the method further comprises downloading, by the router, the Internet content of the data item from the public Internet via the first interface for providing to the user device only if it is not returned by one of the other routers.

In embodiments, the method further comprises retaining the downloaded Internet content in the memory thereby rendering the data item accessible from the memory for providing in response to a later request.

In embodiments, the method further comprises: determining a popularity indicator for the data item; and using the popularity indicator to determine whether to perform said retaining the downloaded Internet content.

In embodiments, the method further comprises determining, as the popularity indicator, a number of users associated with the data item, and wherein said retaining of the Internet content is performed in response to the processor determining that the determined number of users exceeds a threshold value.

In embodiments, the threshold value is one. The threshold value may be two, three, etc. (i.e. any integer number, such as 10, 100, 1000 etc.).

In embodiments, the number of users associated with the data item is determined based on metadata of the data item.

According to a third aspect disclosed herein, there is provided a computer program product comprising computer-executable code embodied on a computer-readable storage medium configured so as when executed by one or more processing units to perform the steps according to the third aspect.

### BRIEF DESCRIPTION OF FIGURES

For a better understanding of the present invention, and to show how embodiments of the same may be carried into effect, reference is made to the following figures in which:

FIG. 1 shows a system according to embodiments of the present invention;

FIG. 2 shows direct data item retrieval from a router;

FIG. 3 shows data item retrieval from a router after one hop;

FIG. 4 is a block diagram of a router;

FIG. 5 is a flowchart illustrating a method performed by an initial router;

FIG. 6 shows data item retrieval from a router after two hops; and

FIG. 7 is a flowchart illustrating a method performed by a further router.

### DETAILED DESCRIPTION OF EMBODIMENTS

The described embodiments provide a means of saving potentially large amounts of data within a network comprising a plurality of routers each connected to the internet. For example, a company may deploy routers around an office space to provide internet access to its employees. The company pays an ISP generally on a per-byte basis (e.g. a set cost per Gigabyte (GB) or Terabyte (TB) downloaded). This means that if each of 100 employees downloads “Video A” which is 5 megabytes (MB), the company will pay for the entire 500 MB downloaded. According to embodiments of the present invention, on the other hand, the routers are able to share the file between themselves for providing it to the employees. Hence, at least one router will download Video A, at a cost of 5 MB, and share it between the routers which can then provide it to the employees without needing to download it again from the internet. The total data saving in this example is (500−5) MB=495 MB.

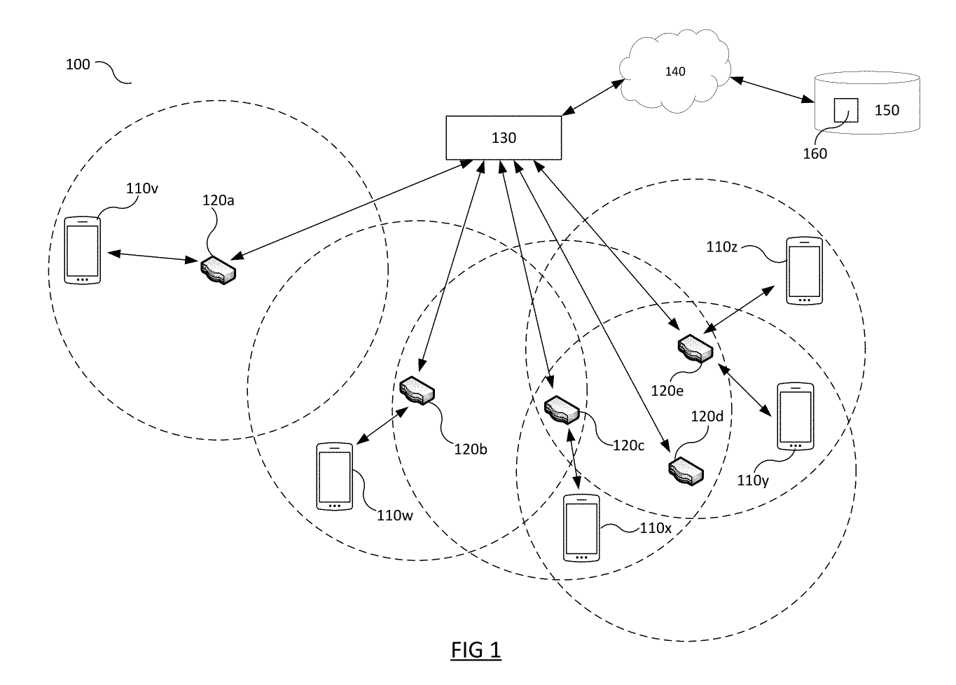

FIG. 1 shows a system 100 comprising a plurality of routers 120a-e each connected to the public Internet 140 via an ISP 130 by a respective data connection which may be either direct, or via one or more intermediate routers (not shown). These connections may preferably be by a wired data connection such as an Ethernet, though a wireless connection may also be used for some or all of the connection (some of all of the “hops” between intermediate routers) as is known in the art.

The ISP 130 connects to the public Internet 140 which allows access to a remote data storage such as a remote server 150 comprising one or more memories for electronically storing data. As is well known in the art and so mentioned only briefly here, the routers 120a-e are able to both transmit data to and receive data from the remote server 150 (and other remote storages not shown in FIG. 1) by communicating with the server 150 over the Internet 140 using the connection provided by the ISP 130.

Each router 120, in addition to the data connection (usually wired) to the ISP 130, is provided with a second communication means allowing it to communicate wirelessly with any capable devices within a wireless communication range (shown by dashed circles in FIG. 1). For example, each router 120 may comprise one or more radio and/or microwave frequency antennae configured to send and receive modulated signals to and from devices such as users' smart phones within the range of the antennae.

These ranges may overlap in space. Note that though illustrated by circles in FIG. 1, this is only for clarity, and it is appreciated that the ranges of the routers 120 form a 3-dimensional volume around each router 120 and is not necessarily equal in all direction (i.e. not necessarily a sphere) due to anisotropies such as walls and floors within the environment (e.g. within an office space).

FIG. 1 shows five user devices 110v-z which are smart phones. The term “user device” is used herein to refer generally to any electronic device used by a user to connect to a router 120 in order to access data via the wireless communication (e.g. to connect to the Wi-Fi in an office).

User device 110v is within range of and in communication with router 120a. User device 110w is within range of and in communication with router 120b. User device 110x is within range of both router 120c and router 120d, but is in communication with only router 120c. User device 110y is within range of both router 120d and 120e but is in communication with only router 120e. User device 110z is within range of and in communication with router 120e.

A data item 160 (Internet content item) is stored on remote server 150. This data item 160 may be, for example, Video A mentioned above, or any other piece of data which one or more users wishes to download using his user device 110, such as an image file, video file, text file etc., or other Internet content. That is, content available on the public Internet, from the server 150 in this case.

As mentioned above, if each of the respective users of the user devices 110v-z wishes to download data item 160, the data item 160 will traditionally be downloaded five separate times: each user device 110 sends a data retrieval request to the server 150 via the respective router 120, the ISP 130, and over the internet 140 prompting the server 150 to return the requested data (data item 160) via the return pathway to the requesting user device.

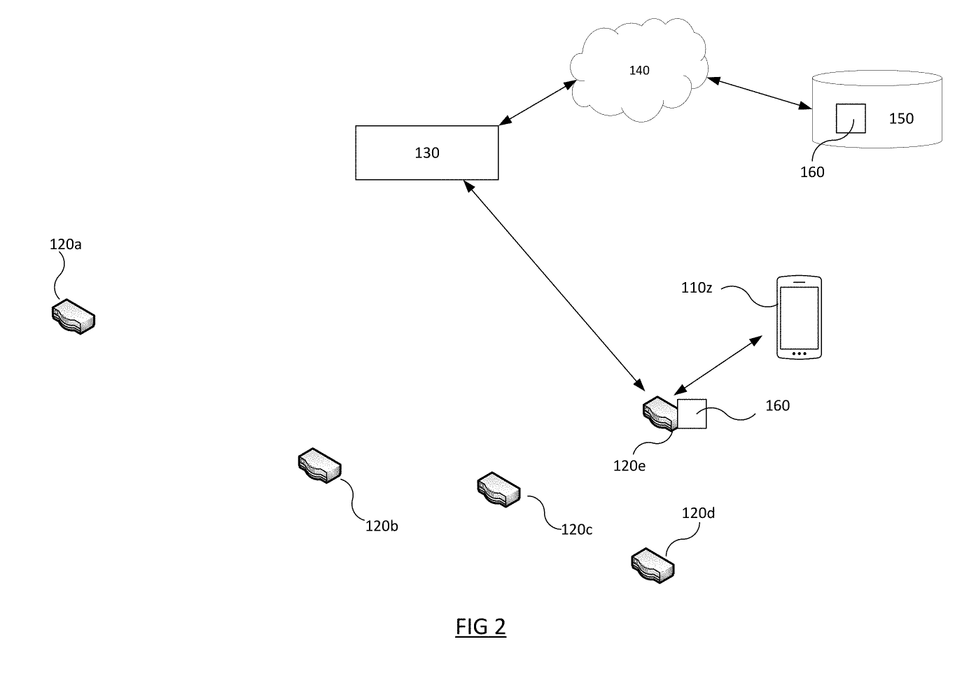

FIG. 2 illustrates an improvement to this provided by the present invention by allowing the routers 120 themselves to locally store data (such as the data item 160). Say, for example, that user device 110y from FIG. 1 previously downloaded data item 160. Router 120e stores the data item 160 in a memory local to the router 120e itself (this is explained in more detail below).

Later, in this example, user device 110z wishes to download data item 160 and sends the request as normal to router 120e. Instead of simply accessing the internet (and incurring charges from the ISP 130), the router 120e checks its local memory to first determine whether or not it has the requested data item 160 available.

If the router 120e does have the data item 160 (as in this example) it simply returns the data item 160 to the requesting user device 110z. Advantageously, this is does require the use of the public Internet connection.

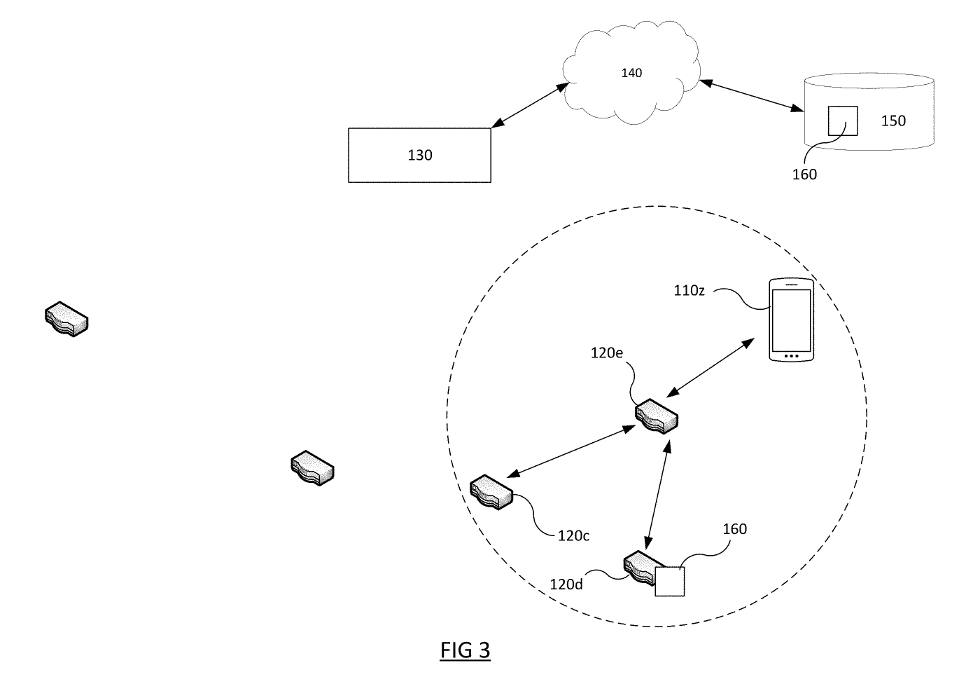

If the router 120e does not have the data item 160, as shown in FIG. 3, it broadcasts a message which is received by devices within range of the router 120e (router 120c and router 120d in the example) requesting the data item 160. This broadcasting may be done via the same wireless communication means as the connection to the user devices 110 (Wi-Fi in the above example) or may be a different wireless technology such as Bluetooth. In any case, this message prompts the receiving routers to check their own local memories to determine whether they have the data item 160 available. If so, as is the case with router 120d in this example, the router returns the data item 160 to the requesting router 120e which can then provide it to the user device 110z. Router 120c does not have the data item 160 available and so, in response to receiving the message and determining that it does not have the data item 160, it can either send a response to router 120e indicating that the requested data is not available, can send a further broadcast message (described in more detail below), or can do nothing.

Note that if router 120e does not receive the data item 160 back from one of the other routers (either by receiving explicit “data not available” messages from all routers within range, or by not receiving any response for a predetermined amount of time and “timing out”), it can revert to the Internet connection as described above and download the data item 160 from remote server 150.

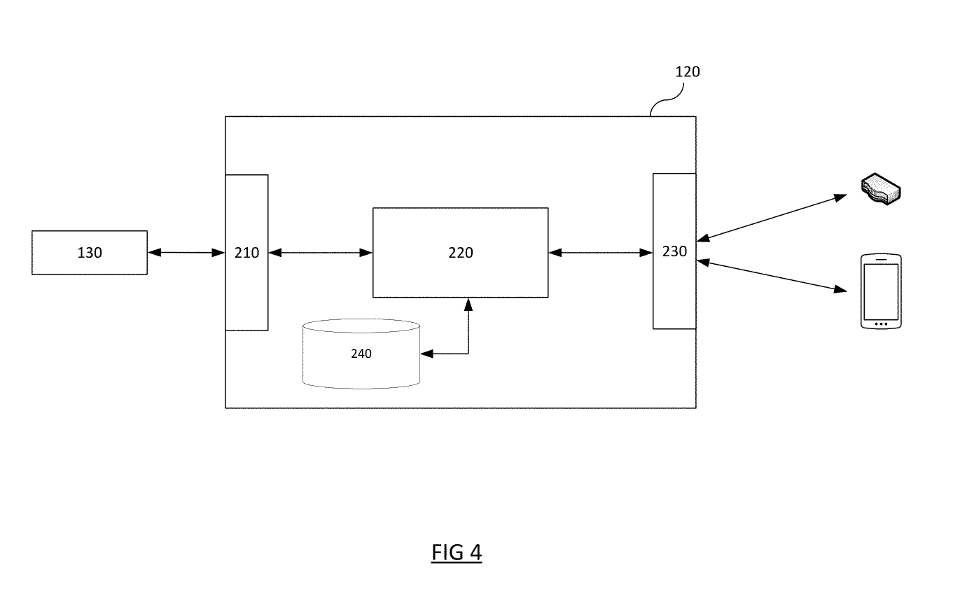

FIG. 4 is a block diagram illustrating a router 120 in accordance with embodiments of the present invention. It is understood that router 120 shown in FIG. 4 represents any one of the routers 120a-e in FIGS. 1-3, as each router is substantially the same in structure and functionality.

The router 120 comprises a first interface 210, a processor 220, a second interface 230, and a memory 240. The processor 220 is operatively coupled to each of the first interface 210, the second interface 230, and the memory 240.

The first interface 210 comprises one or more data ports for sending and receiving data to and from the ISP 130 as is known in the art. The second interface 230 similarly comprises one or more data ports for the sending and receiving of data to and from external devices. These external devices include the user devices 110 and routers 120 as shown in FIG. 1. Note that, as mentioned above, a different port and/or a different wireless technology altogether may be used for communication with routers 120 as is used for communication with the user devices 110. For the sake of simplicity, second interface 230 is shown as a single functional block in FIG. 4.

The processor 220 is also represented by a functional block in FIG. 4 and maybe implemented in hardware, such as one or more individual Application-Specific Integrated Circuits (ASICs) or Field-Programmable Gate Arrays (FPGAs), or software being code configured so as when run on one or more processing units such as Central Processing Units (CPUs) to perform the steps described herein. That is, the term “processor” refers to a processing component for processing incoming Internet content requests, and which can be implemented in software, hardware, or any combination thereof.

The memory 240 comprises one or more electronic storage units for the electronic storage of data, as are well known in the art. For example, magnetic and/or solid-state storage.

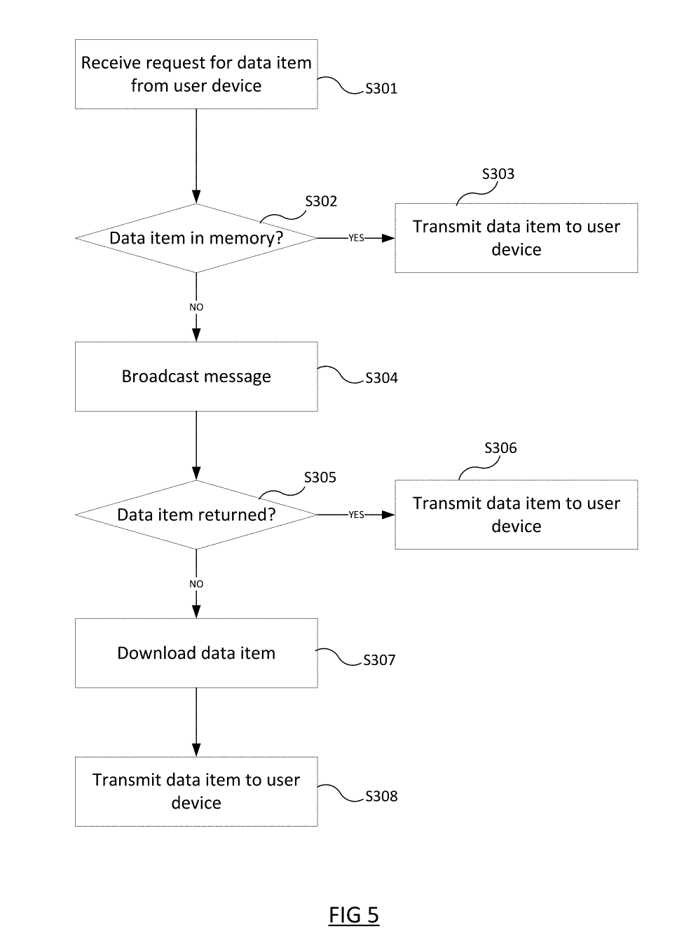

In operation, the processor 220 is configured to perform the method illustrated in FIG. 5, described below.

At step S301, the processor 220 receives, via the second interface 230, a request for the data item 160 from a user device 110. At this point in time, the processor 220 of the router 120 needs to access the data item 160 from somewhere in order to provide it to the requesting user device 110. The data item 160 may be stored locally in memory 240 at the router 120, at a corresponding memory of a further router different from the router which received the request from the user device 110, or at a remote storage location 150. The processor 220 checks these in turn.

At step S302, the processor 220 accesses local memory 240 to determine if the data item 160 is stored therein. If the data item 160 is stored in memory 240, the processor retrieves it proceeds to step S303 in which the data item 160 is transmitted by the processor 220 via the second interface 230 to the user device 110, ending the process without having to access the public Internet.

If, instead, the processor 220 determines that the data item 160 is not available in memory 220, it proceeds to step S304 and broadcasts a message via the second interface 230 requesting the data item 160 from any one or more other routers in the local wireless communication range. This message causes any receiving router(s) which have access the data item 160 (in their local memory, not via the internet 140=as all of the routers 120 have access to the data item 160 using the internet 140; the aim here is to reduce the number of times the data item 160 is downloaded over the Internet).

At step S305, the processor 220 either receives the data item 160 back from an external router, or determines that the data item 160 has not been received back from an external router. If the processor 220 does receive the data item 160, it proceeds to step S306 in which, similarly to step S303, it transmits the data item 160 to the requesting user device 110, again without having to access the public Internet.

In order to determine the negative (that the data item 160 has not been received back), the processor 220 can apply a time-out, i.e. the processor 220 can wait a predetermined amount of time after broadcasting the message and if no response(s) have been received by the end of that time the processor 220 will consider this an indication that the data item 160 is not available from any of the other routers. This may be advantageous in that the routers which receive the broadcast message do not have to reply to the broadcasting router. Alternatively, however, in some embodiments the routers which receive the broadcast message check their local memory and if they do not have the data item 160 they reply with a “data not available” (or similar) response. In these embodiments, the processor 220 is able to explicitly determine that the data item 160 is not available based on the response(s) from the other router(s).

However it is done, once the processor 220 determines that the data item 160 is not received from another router, it proceeds to step S307 in which it downloads the data item 160 from remote storage 150 as explained above and so not repeated here. Finally, in S308, the processor transmits the data item to the user device 110 which requested it.

Additionally, the processor 220 may store the data item 160 to local memory 240 (regardless of how it was retrieved). In particularly advantageous embodiments, the processor 220 stores the data item 160 to memory 240 immediately after step S307, and thus the router 120 in question becomes a “host” of that data item 160.

In some embodiments, the processor 220 simply stores every data item (i.e. data item 160 and any further data items downloaded at other times) which is downloaded into memory 240. As each processor 220 is configured the same, this can be considered as creating a “user web” for every downloaded file. That is, every file which is downloaded by a user anywhere in the local network of routers 120 will be stored somewhere in the local network (i.e. at one or more of the routers 120) and is therefore accessible to (other) users at later time(s) without the need to download it again over the Internet 140. To implement this with a fixed amount of storage, data can for example by purged (i.e. deleted or marked for deletion) from local memory if it is not requested by any user within a time limit. That is, a stored Internet content item may be purged unless requested again, by a user or another router, within the time limit.

In other embodiments, the processor 220 can selectively store data item 160. That is, the processor 220 may or may not store the data item 160 in local memory 240, based on a predetermined criterion. This criterion may, for example, be whether or not the data item 160 is associated with more than one user (or a set number of users being two or more). In this case, the processor 220 would only store the data item 160 to memory 240 if it determines that the data item 160 is associated with two or more users. This can be done explicitly (e.g. using a flag in the metadata of the file itself) or implicitly (e.g. data items 160 which were requested by a social media app of running on the user device 110 can be assumed to be associated with more than one user, due to the nature of social media data typically being shared around many users).

In other embodiments, the routers may share between themselves information about items of Internet content being requested by users, to identify content as popular. For example, content items that are requested across the routers more than a certain number of times within a time interval. In that case, only content identified as popular may be stored locally at the routers, for example the next time the Internet content item is requested. More generally, the routers may store information, such as request metrics, to determine which Internet content items to store locally.

In further embodiments, the metadata of downloaded files could be enhanced with additional information pertaining to the number of user requests (i.e. the number of requests for that particular file received from user devices). Every time a user shares this file, the metadata gets updated with that additional user (i.e. the count is increased by one). The processor 220 can then selectively store a data item based on the count in the metadata (e.g. store if count above a predetermined threshold, such as 50 requests for download). In determining whether or not to store the data item, the processor 220 could also take into account the file size of the data itself (e.g. store data items which are larger than, or smaller than, a predetermined threshold). A combination of these two may also be used. For example, store the data item if [file size<1 MB]AND[100<user count]; [1 MB<file size<50 MB]AND[20<user count<100]; [50 MB<file size]AND[20<user count] etc.

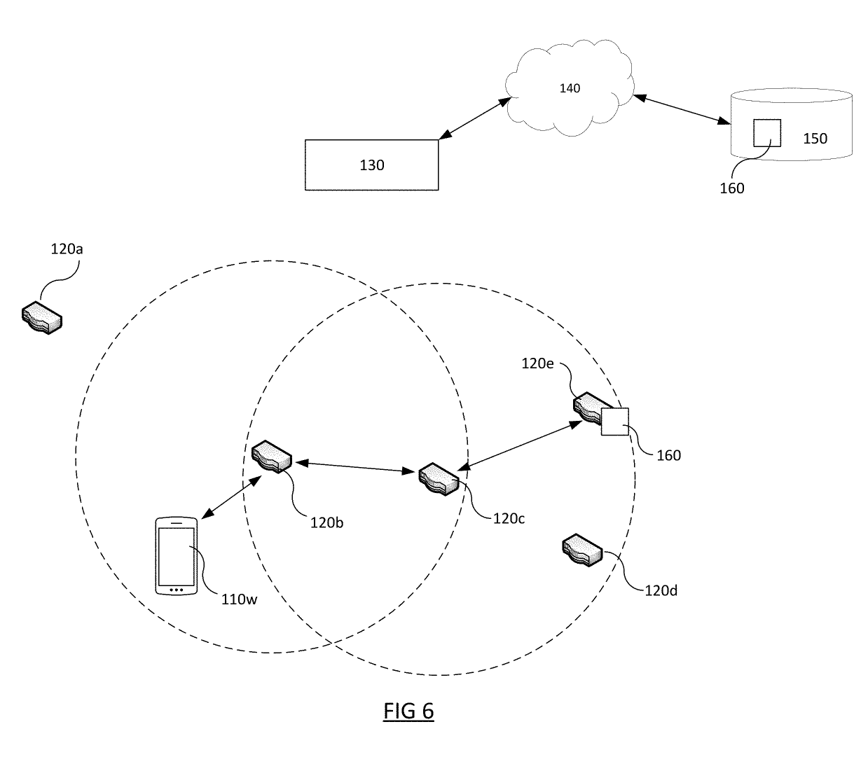

FIG. 6 illustrates the “chaining” of broadcast messages. That is, user device 110w has messaged router 120b to request data item 160. In response, router 120b determines that it does not have the data item 160, and broadcasts message which is received by router 120c. Router 120c, being similarly configured, also determines that it does not have the data item 160, and broadcasts a second message. This second message is received by router 120e which does have the data item 160 and so returns it to router 120c which forwards it to router 120b in order for router 120b to return the data item 160 to the user device 110w. Note that the user device 110w can advantageously be unaware that the data item 160 is not downloaded in the traditional sense (i.e. not retrieved over the public internet 140). That is, the user device 110w simply sends out a standard data request to router 120b. The relaying, or “sharing”, of data between the routers 120 to avoid downloading wherever possible is performed in a manner which is hidden from the user device 110w itself.

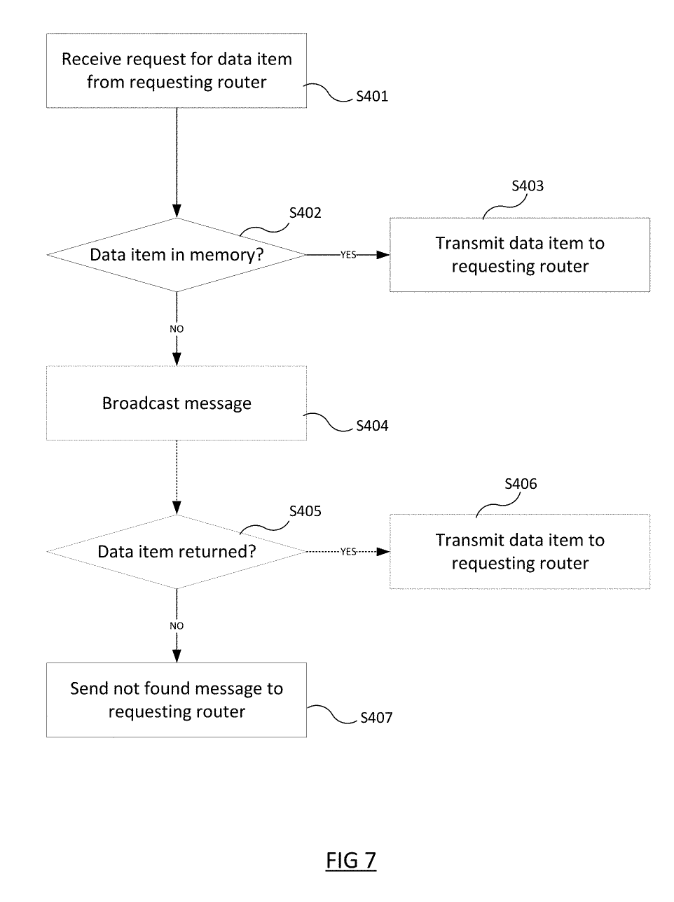

FIG. 7 is a flowchart illustrating a method performed by the processor 220 which is acting as part of the “chaining” (or “relaying”) as described above in relation to FIG. 6. Hence it is appreciated that the processors 220 of each router 120 are each configured to be able to perform either the method of FIG. 5 or FIG. 7.

In step S401, the processor 220 receives a request for the data item 160 from the requesting router. Note that this request is the broadcast message output in step S304 of the FIG. 5 method.

In response to receiving the request, the processor 220, at step S402 checks its local memory 240 to determine whether or not the data item 160 is stored there. Note that this mirrors step S302 from earlier. If the data item 160 is stored in local memory 240, the processor 220 retrieves it and transmits it to the first router via second interface 230, S403. If the data item 160 is not available (not stored in the accessible local memory 240), the processor 220 may send an error message such as “requested data not available” to the first router (i.e. skip to step S407 of FIG. 7), or may do nothing (in embodiments in which the first router operates with a “time out” as mentioned above). However, in each of these cases the “chaining” effect between routers only extends one level deep. That is, the processor 220 performing the method of FIG. 7 is the last in the chain. This means that even if the data item 160 is available to one of the routers 120 in the network, if that router is further away from the router to which the user device 110 sends its initial request than one “hop”, the data item 160 will not be “discovered” and thus the initial router will download the data item 160 again (in step S307). It would be desirable to avoid this as it uses more ISP data than necessary.

One solution to this is shown in steps S404-406 of FIG. 7. In step S404, the processor 220 broadcasts a further message in the same manner as before in order to request the data item 160 from nearby routers. Also in the same manner as described above, the router 120 waits (potentially for only a predetermined amount of time) at step S405 in order to determine if the data item 160 has been returned. If the data item 160 is returned, then the processor 220 proceeds to step S406 and provides it to the router from which the request was received at step S401. If the data item 160 is not returned, then the processor 220 proceeds to step S407 and indicates to the requesting router that it does not have the data item 160 available.

Note that this method does not include a step of downloading the data item 160 over the Internet 140. Though it is not excluded that a relaying router (performing the method of FIG. 7) could download the data item 160 and forward it to the user device 110, this router is not “central” in the same way that the initiating router (the router in communication with the user device 110) is, and therefore may download the data item 160 when not necessary. Hence, it is preferable that only the central, initial router 120 reverts to the Internet 140 connection. This has the further advantage that this router can then store the data item 160 for retrieval at a later time.

Given the above, it is appreciated that potentially very large data savings on the ISP 130 and public Internet 140 side of the system can be achieved. For example, a building in an office may have 1000 employees, and all these employees are connected to company Wi-Fi system to access applications on their mobile. 500 employee's mobiles have a messaging application. Now there are 10 viral videos (data items 160) of 10 MB size each where every user of the messaging app wants to download and view the videos.

In this example, if every user downloaded the videos this would result in 10 videos*14 mb data*500 users=70,000 MB being downloaded.

In the present invention, on the other hand, the videos are downloaded only once and stored locally at one (or more) routers 120 in a manner which facilitates sharing of the data. In this example, only 10 videos*14 mb data*1 data hotspot=140 MB is downloaded and then shared to all the 500 users. This saves 69,860 MB compared to the prior art system.

It is appreciated that the routers 120 are provided in the network 100 for the traditional primary use of providing Internet access to user device 110, and that the sharing of data between routers 120 may, as each is provided with a finite bandwidth, have a detrimental impact on this primary use. To avoid this, the processor 220 may be configured to prioritise the internet access functionality over the retrieval of data from external routers. For example, if a processor 220 is currently in the process of retrieving a requested data item 160 from an external router (using up at least some bandwidth) when it receives a request for a large amount of data (from, e.g. a second user device 110) which requires full use of the bandwidth, the processor 220 can simply drop the data item 160 retrieval process in order to provide the internet access to the second user device 110. Hence, it is generally preferable that the sharing of data between routers 120 uses an unreliable transfer protocol (e.g. User Datagram Protocol (UDP) as is known in the art) which allows for the dropping of data packets.

Embodiments of the present invention also allow for an automatic handover procedure between routers 120. That is, if a user device 110 is currently receiving data item 160 from router 120b (from local memory 240 at that router 120b) but then moves out of range and into range of another router 120c, this new router 120c simply receives the request for the data item and identifies that it is available at router 120b, and retrieves it which allows the user device 110 to continue receiving the data item 160.

Note references to software executed on at least one processor (or similar) can mean all of the software are executed on the same processor, or that portions of the code can be executed on different processors, which may or may not be collocated. For example, the various functionalities described above can be individually implemented on one or multiple processors, for example embodied in one or more servers; different functionalities can be implemented on the same processor(s)/server(s) or on different processors/servers. In practice, the methods described above may be implemented by computer-readable code, in which case different code portions may be implemented on different processors at different locations, possibly in different routers. Note also that “computer storage” refers generally to one or more computer-readable storage devices, such as magnetic or solid-state storage devices. For multiple devices, there may or may not be spatially collocated. The system code can be stored for execution at the system in question in one or more computer readable memory devices. The features of the techniques described herein are platform-independent, meaning that the techniques may be implemented on a variety of commercial computing platforms having a variety of processors. For example, the systems may include a computer-readable medium that may be configured to maintain instructions that cause the systems, and more particularly any operating system executed thereon and associated hardware of the system to perform operations. Thus, the instructions function to configure the operating system and associated hardware to perform the operations and in this way result in transformation of the operating system and associated hardware to perform functions. The instructions may be provided by the computer-readable medium to the system processor(s) through a variety of different configurations. One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A router configured to cooperate with one or more other such routers to provide Internet content to users, the router comprising:
a memory for storing data items available to the router;
a first interface for connecting to the public Internet;
a second interface being a wireless interface having a local wireless communication range; and
a processor configured to:
receive a request for a data item comprising Internet content from a user device within the local wireless communication range via the second interface;
determine whether the requested data item is stored in the memory; and
if the data item is stored in the memory, provide the data item to the user device via the second interface; and
if the data item is not stored in the memory, broadcast a message requesting the data item from any one or more other routers in the local wireless communication range, thereby causing that other router to return the data item if that router has the data item available to it;
wherein the router downloads the Internet content of the data item from the public Internet via the first interface for providing to the user device if it is not returned by one of the other routers.

2. The router according to claim 1, wherein the processor is further arranged to retain the downloaded Internet content in the memory thereby rendering the data item accessible from the memory for providing in response to a later request.

3. The router according to claim 2, wherein the processor is further arranged to: determine a popularity indicator for the data item; and to use the popularity indicator to determine whether to perform said retaining the downloaded Internet content.

4. The router according to claim 3, wherein the processor is configured to determine, as the popularity indicator, a number of users associated with the data item, and wherein said retaining of the Internet content is performed in response to the processor determining that the determined number of users exceeds a threshold value.

5. The router according to claim 4, wherein the threshold value is one.

6. The router according to claim 4, wherein the number of users associated with the data item is determined based on metadata of the data item.

7. The router according to claim 6, wherein the processor is configured to determine the popularity indicator as a type of source from which the request for the data item was received.

8. The router according to claim 7, wherein the downloaded Internet content is retaining if the type of source is identified as a social media system.

9. The router according to claim 2, wherein the processor is configured to retain all Internet content it downloads, the stored content being retained at the router for a limited time interval.

10. The router according to claim 1, wherein the second interface is a Bluetooth interface having a local Bluetooth communication range.

11. The router according to claim 1, wherein the second interface is a Wi-Fi interface having a local Wi-Fi communication range.

12. The router according to claim 1, wherein the processor is configured to retain the data item only if a file size of the data item exceeds a threshold file size.

13. The router according to claim 1, wherein the data item is a video file.

14. A method, performed at a router, of cooperating with one or more other such routers to provide Internet content to users, the router comprising a memory for storing data items available to the router, a first interface for connecting to the public Internet, and a second interface being a wireless interface having a local wireless communication range, the method comprising:
receiving a request for a data item comprising Internet content from a user device within the local wireless communication range via the second interface;
determining whether the requested data item is stored in the memory; and
if the data item is stored in the memory, providing the data item to the user device via the second interface; and
if the data item is not stored in the memory, broadcasting a message requesting the data item from any one or more other routers in the local wireless communication range, thereby causing that other router to return the data item if that router has the data item available to it;
wherein the method further comprises downloading, by the router, the Internet content of the data item from the public Internet via the first interface for providing to the user device if it is not returned by one of the other routers.

15. The method according to claim 14, further comprising retaining the downloaded Internet content in the memory thereby rendering the data item accessible from the memory for providing in response to a later request.

16. The method according to claim 15, further comprising: determining a popularity indicator for the data item; and using the popularity indicator to determine whether to perform said retaining the downloaded Internet content.

17. The method according to claim 16, further comprising determining, as the popularity indicator, a number of users associated with the data item, and wherein said retaining of the Internet content is performed in response to the processor determining that the determined number of users exceeds a threshold value.

18. The method according to claim 17, wherein the threshold value is one.

19. The method according to claim 17, wherein the number of users associated with the data item is determined based on metadata of the data item.

20. A computer program product comprising computer-executable code embodied on a computer-readable storage medium configured so as when executed by one or more processing units, cause the processing units to perform operations at a router for cooperating with one or more other such routers to provide Internet content to users, the router comprising a memory for storing data items available to the router, a first interface for connecting to the public Internet, and a second interface being a wireless interface having a local wireless communication range, the operations comprising:
receiving a request for a data item comprising Internet content from a user device within a local wireless communication range via the second interface;
determining whether the requested data item is stored in the memory; and
if the data item is stored in the memory, providing the data item to the user device via the second interface; and
if the data item is not stored in the memory, broadcasting a message requesting the data item from any one or more other routers in the local wireless communication range, thereby causing that other router to return the data item if that router has the data item available to it,
wherein the operations further comprise downloading, by the router, the Internet content of the data item from the public Internet via the first interface for providing to the user device if it is not returned by one of the other routers.
